(19) United States
(12) Patent Application Publication
(10) Pub. No.: US 2010/0032172 A1
(43) Pub. Date: Feb. 11, 2010

(54) Combined Seawater and Firewater System

(75) Inventors: Jan Erik Aspunvik, Honefoss (NO); Erik Drage, Gjettum (NO)

Correspondence Address: BIRCH STEWART KOLASCH & BIRCH, PO BOX 747, FALLS CHURCH, VA, 22040-0747, US

(73) Assignee: Aker Engineering & Technology AS, Lysaker (NO)

(21) Appl. No.: 12/223,322

(22) PCT Filed: Feb. 13, 2007
(86) PCT No.: PCT/NO2007/000046

§ 371 Date: Jul. 29, 2008

(30) Foreign Application Priority Data
Feb. 15, 2006 (NO) 2006 0725

(51) Int. Cl. A62C 35/00

(52) U.S. Cl. 169/13

(57) ABSTRACT

A combined seawater and firewater system, characterised in that the system comprises two or more pumping stations (2), the pumping stations each comprising two or more pumps (3), where each pumping station (2) is connected to a separate distribution header (7) for distribution of seawater and firewater, where essential consumers, such as generator cooling, thruster cooling and firewater monitors, are connected to two or more separate distribution headers (7), and non-essential consumers are connected to one of the distribution headers (7).

### FIELD OF INVENTION

The present invention relates to an alternative concept for safe and secure systems for providing seawater and firewater for onshore and offshore plants and installations and vessels. More specifically the invention relates to a combined firewater and seawater system for plants and installation for oil and/or gas exploration and production in addition to processing plants both onshore and offshore.

### TECHNICAL BACKGROUND

At installations offshore for oil and/or gas exploration and production, there is a need for seawater for different purposes, such as cooling, e.g. cooling of generators, thrusters, drilling cooling, utility cooling etc., fresh water making, utility consumption, such as flushing and mud mixing, and HVAC. Additionally, there is a need for a firewater system for safety reasons.

Traditionally, seawater systems and firewater systems are separated systems, having separated pumps and piping onboard the installation. The traditional seawater system has redundant pump capacity, as the pumping station comprises two or more pumps that are normally operated in a shared configuration. The pumps that normally are located in one pumping station have a common riser to the top deck, a common main pipe and a distribution system.

The traditional firewater system has two pumping stations, each having two or more pumps operated in a shared configuration. In a firewater system there are separate risers for each pumping station. The two pumping station delivers water to a ring main pipe that delivers water to the fire different extinguishing equipment, as hose reels, hydrants, sprinkler system etc.

Onshore plants for processing of oil and gas have more or less the same needs for seawater and firewater as the offshore based systems, and are traditionally equipped with separate seawater system and firewater system as described above.

The traditional configuration is, however, relatively heavy and space consuming. Additionally, while the seawater system normally is operated on a continuous basis, the firewater system is started on demand, or for testing. Accordingly, the firewater pumps have to be started on demand, giving well known pump start-up problems such as failure to start. Additionally, water hammering is a known problem if the valves to the consumers are opened to drain the system before the pumps are started.

One object of the present invention is to provide a new system being easier to operate and less expensive than the systems according to the prior art at the same time as it is to be at least as safe as, and preferably safer, than the prior systems. Additionally, it is an object providing a system having a higher availability than the systems according to the prior art.

### SUMMARY OF THE INVENTION

According to the present invention there is provided a combined seawater and firewater system, wherein the system comprises two or more pumping stations, the pumping stations each comprising two or more pumps, where each pumping station is connected to a separate distribution header for distribution of seawater and firewater, where essential consumers, such as generator cooling, thruster cooling and firewater monitors, are connected to two or more separate distribution headers, and non-essential consumers are connected to one of the distribution headers. By providing two or more separate pumping stations connected to separate distribution headers, redundancy both for the firewater and the seawater system is provided. Additionally, by providing connection for essential consumers to two or more distribution headers, the delivery of water to the essential users is redundant.

Preferably, that the system comprises two pumping stations, and where each pumping station, and the connected distribution header have the capacity that is equal to or larger than the design duty of the essential consumers, including firewater. By connecting the essential seawater and firewater consumers to two separate distribution headers, redundancy is provided for water supply, and water supply is provided even after a serious damage to one of the headers and/or pumping stations. A double system where each separate pumping station and connected distribution header has a capacity that is equal to the design duty of the total design duty of the essential users is normally sufficient to give a failsafe system that satisfies the needs of the owner and the requirement from authorities and/or classification societies.

It is preferred that non-essential consumers may be disconnected from the distribution headers by means of sectionalisation valves in an emergency situation giving priority for firewater and essential seawater consumers. By disconnecting the non essential consumers, the firewater system is prioritized in an emergency situation, thus, preventing pressure drop and maintaining capacity to deliver to the essential consumers.

It is also preferred that check valves prevents water from returning from an essential seawater and firewater consumers after pressure drop in one of the distribution headers.

If the check valves were not present, a pressure drop in one of the distribution headers, e.g. due to a serious leak or pump failure, would result in leakage of water through essential consumers into the damaged part of the system.

Preferably, said sectionalisation valves are high reliability type valves. High reliability valves, or optionally two or more serially connected valves, are needed to have the necessary reliability in the disconnection or sectionalisation operation.

The present seawater and firewater system comprises fewer parts and has a simpler construction than the prior known systems. This results in a reduction in space demand and weight of the system. Additionally, the present system makes it possible to minimize the number of potential leak points, such as hull penetrations for a floating construction.

As the operating pumps continue operation with priority for firewater when shifting from seawater mode to firewater mode, firewater at the requested amount and pressure is instantly available in an emergency situation.

### SHORT DESCRIPTION OF THE FIGURES

FIG. 1 is a principle sketch illustrating the present seawater and firewater system.

### DETAILED DESCRIPTION OF THE INVENTION

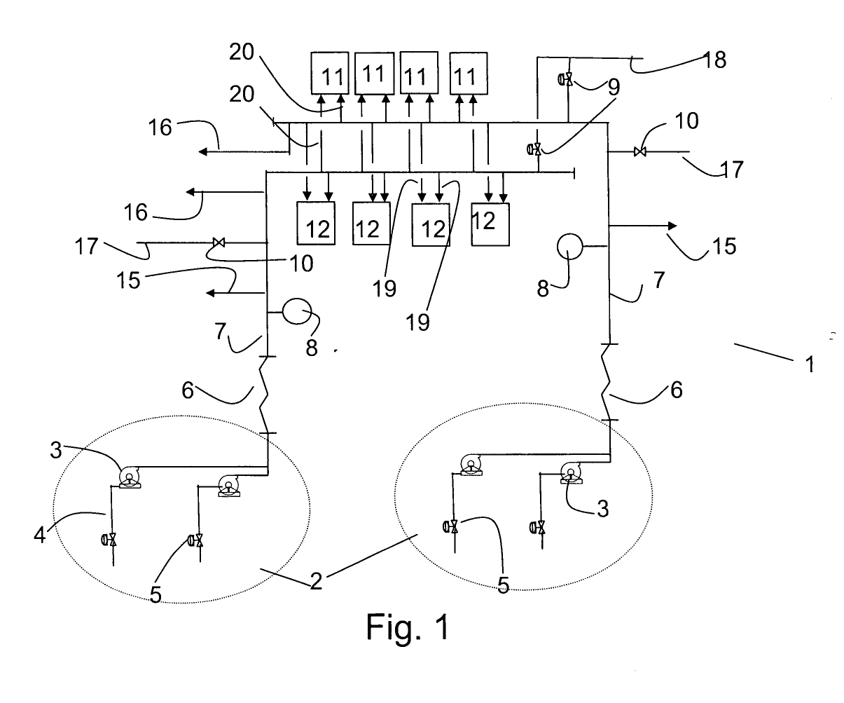

FIG. 1 illustrates the principle of a combined seawater and firewater system 1 according to the present invention for installation onboard an offshore installation or a vessel. Minor adaptations that are not essential to the present invention may be necessary and/or desired on systems at an onshore plant.

The system comprises two pumping stations 2, being separated from each other as in a conventional firewater system. Preferably, the pumping stations are situated one at the starboard side and one at the port side of the installation or vessel. Both pumping stations comprise two or more pumps 3. Normally, both pumping stations comprise two identical pumps 3 as illustrated in the FIG. 1. Additionally, each pumping station may comprise one or more additional pumps being in a maintenance or stand by mode.

Each pump 3 is connected to a water intake line 4, for introduction of water from the sea. Each intake line 4 is controlled by a water intake valve 5. The output from the pumps in one pumping stations is collected and is led from the pumping station the topside of the vessel or installation, in one riser 6. Each riser 6 is connected to a separate and dedicated distribution header 7. The riser 6 may not be required in an onshore plant. Accordingly, the riser is not essential to the invention. Additionally, it may be required of some reason or another to provide one riser for each pump.

A plurality of distribution lines 15, 16, 17, 18, 19, 20 are connected to the distribution headers 7 for distribution of water from each distribution header 7 to the intended uses as mentioned above.

Non-essential consumers, such as watermaking, flushing, and mud mixing, in line 18, respectively, may be shut down by means of sectionalisation valves 9, to direct the water to essential consumers if needed. Additionally, a testing line 17 having its own valve 10, is provided on both headers for the purpose of testing the water flow and the capacity of one of the distribution headers and pumping stations at the time.

Pressure switches 8 are provided at both distribution headers 7. If the pressure drops in one of the distribution headers, due to a failure or large water consumption, the pumps will be regulated and/or standby pumps will be started.

Essential consumers, such as generator cooling, thruster cooling and firewater monitors, are connected to both distribution headers to ensure supply from either header. Examples of essential consumers being supplied by water from both distribution headers are generators 11 and thrusters 12, in addition to lines 16 for monitors/deluge. The essential consumers are provided with not shown check valves to prevent loss of water though an essential consumer, such as a generator, in case of loss of pressure in one of the distribution headers.

The firewater system is provided with firewater from the two separate headers 7 in lines 16 to provide a redundant system that are able to deliver firewater even if one of the headers 7, one of the risers 6 or one of the pumping stations 2 are damaged.

In an emergency situation were the firewater system is to be activated, the sectionalisation valves 9 controlling distribution lines to utility consumers are closed down and the pumps continue their operation with priority for the firewater system and the essential consumers. Drilling emergency seawater can be supplied from the distribution headers via non shown bypasses with orifices.

The redundancy principle of the design ensures adequate firewater and seawater capacity even after damage on any of the pumps, pumping stations or distribution headers. The two pumps in the pumping stations may all be operated at a reduced capacity during normal operation. Alternatively, two pumps may be operated at 100% of their capacity, while the other two are in standby mode. Standby firewater pump starts upon demand, e.g. if the pressure drops in the distribution headers. Most pump failures will therefore be discovered during normal operation. Additionally, start of pumps in emergency situations, where pumps may fail to start, is avoided. Additionally, pumps may be tested at high, or full, load by alternating between pumps during normal operation and/or during special test procedures. For a single failure (rupture of port or starboard distribution line) all essential users will be supplied with water from the alternative distribution system from opposite side. Consequently, the present design provides for a combined redundant system both for seawater and firewater, and avoids the need for a separate redundant firewater system, adding cost, weight and complexity to a vessel or platform.

It is, however, important that the distribution headers are routed and/or protected to avoid damage to both header due to a common accident; typically fire, explosion or mechanical impact.

It is also advantageous that the pumps are continuously operated, so that traditional firewater pump start-up problems, in an emergency situation are avoided. Additionally, system drainage and water hammering are avoided as the firewater system is pressurised at all times and ready on demand. As the supply header is common for both the seawater system and the firewater system, the continuous flow in the headers will enhance the frost protection.

As an antifouling measure, hypochlorite is added to seawater and firewater system. A combined system as illustrated in the present description makes it possible to reduce the number of injection points and at the same time improve the control of the injection, as the hypochlorite is injected into the operating pumps. Pumps in standby mode are flushed with hypochlorite solution.

### Example

An exemplary combined seawater and firewater system for an offshore platform has been designed. The design duty for the seawater system was 2800 m³/h, for cooling generators/thrusters, utility cooling, drilling cooling, various usages, fresh water making and HVAC. The design duty for the firewater system was 2370 m³/h, of which 1200 m³/h is for 8 monitors covering the drill floor, and the rest is for cooling generators and thrusters and for drilling cooling for safe emergency shutdown.

The two pumping stations, one at the port and the other at the starboard side, both comprises two identical pumps, each having a capacity of 1400 m³/h at a 12 bar differential pressure, to give a pressure of 9 barg at the main deck.

During normal operation, i.e. for providing seawater to the consumers, each pumping station has the capacity to deliver the total consumption. Operation of the pumps at 50% of their capacity thus provides 50% of the consumption from each pumping station. In case of a failure to one of the pumping stations, the other pumping station may increase its load to 100% and provide of the water needed for normal operation.

During normal operation, the seawater system is at the same a standby system for firewater. As the design duty for the firewater system is 2370 m³/h, the pumps in each pumping station during normal operation operates at 60% of the design duty for the firewater system.

### System Reliability

Tests performed on system availability assessments for these systems indicate that the solution provides equal or even better availability for the fire water system, compared with systems according to prior art.

There are some key aspects that must be considered for a combined system. The sectionalisation valve(s) 9 for shutting down seawater supply for utility consumption is (are) critical. Subject seawater is for flushing/mud mixing/fresh water maker, and is supplied via separate header with actuated block valve with optional bypass for emergency drilling users. To reduce the probability for failure to sectionalise to a minimum, this/these valve(s) shall be configured with high reliability signals from F&G/ESD node and additional redundant “hardwire” from CAP/other systems, and with several solenoids each and shall be of a high reliability type, or optionally two or more valves serially connected to increase the reliability for shutting down the line. The unavailability in sectionalisation is then expected to be compensated by the advantages of the continuous operation of the system (no need for start of pumps/power since pumps are already running). The details regarding sectionalisation requirements (no of valves/solenoids/logic etc) are not yet settled and are not critical for the invention.

For choice of sectionalisation valve(s) experience has proven that use of high reliability type valves are not only very reliable, but also give a quick closing with low “water hammer” effects.

1. A combined seawater and firewater system, characterised in that the system comprises two or more pumping stations (2), the pumping stations each comprising two or more pumps (3), where each pumping station (2) is connected to a separate distribution header (7) for distribution of seawater and firewater, where essential consumers, such as generator cooling, thruster cooling and firewater monitors, are connected to two or more separate distribution headers (7), and non-essential consumers are connected to one of the distribution headers (7).

2. The system according to claim 1, characterised in that the system comprises two pumping stations (2), and where each pumping station (2), and the connected distribution header have the capacity that is equal to or larger than the design duty of the essential consumers, including firewater.

3. The system according to claim 1, wherein non-essential consumers may be disconnected from the distribution headers by means of sectionalisation valves (9) in an emergency situation giving priority for firewater and essential seawater consumers.

4. The system according to claim 1, wherein check valves prevents water from returning from an essential seawater and firewater consumers after pressure drop in one of the distribution headers.

5. The system according to claim 3, wherein said sectionalisation valves (9) are high reliability type valves.

6. The system according to claim 1, wherein each the pumps (3) in each of the pumping station (2) is connected to a common riser (6) leading to the corresponding distribution header (7).

7. The system according to claim 2, wherein non-essential consumers may be disconnected from the distribution headers by means of sectionalisation valves (9) in an emergency situation giving priority for firewater and essential seawater consumers.

8. The system according to claim 4, wherein said sectionalisation valves (9) are high reliability type valves.

9. The system according to claim 2, wherein each the pumps (3) in each of the pumping station (2) is connected to a common riser (6) leading to the corresponding distribution header (7).

10. The system according to claim 3, wherein each the pumps (3) in each of the pumping station (2) is connected to a common riser (6) leading to the corresponding distribution header (7).

11. The system according to claim 4, wherein each the pumps (3) in each of the pumping station (2) is connected to a common riser (6) leading to the corresponding distribution header (7).

12. The system according to claim 5, wherein each the pumps (3) in each of the pumping station (2) is connected to a common riser (6) leading to the corresponding distribution header (7).
